(19) United States
(12) Patent Application Publication
(10) Pub. No.: US 2011/0143290 A1
(43) Pub. Date: Jun. 16, 2011

(54) DEVELOPING TREATMENT METHOD AND COMPUTER-READABLE STORAGE MEDIUM

(75) Inventors: Keiichi TANAKA, Koshi City (JP); Yoshiaki YAMADA, Tokyo (JP); Hitoshi KOSUGI, Koshi City (JP)

(73) Assignee: TOKYO ELECTRON LIMITED, Tokyo (JP)

(21) Appl. No.: 12/963,832

(22) Filed: Dec. 9, 2010

(30) Foreign Application Priority Data
Dec. 10, 2009 (JP) 2009-280047

(51) Int. Cl. G03C 5/00

(52) U.S. Cl. 430/434

(57) ABSTRACT

An extreme ultra violet (EUV) resist film is formed on a wafer W, and then a EUV light is radiated onto the EUV resist film formed on the wafer W so that a predetermined pattern is selectively exposed on the EUV resist film. Thereafter, a developing solution with a concentration of less than 2.38% by weight, whose temperature is adjusted to be 5° C. or higher and less than 23° C. in a supplying equipment group 138, is dispensed from a developing solution supply nozzle 133 to the EUV resist film formed on the wafer W so that the EUV resist film is subject to development. In such a case, a time period during which the developing treatment is performed using the developing solution may be set to fall within the range of 10 seconds or higher to less than 30 seconds. And then, pure water is supplied from a pure water supply nozzle 140 onto the wafer W to clean the wafer. The time period during which the pure water is supplied is set to fall within the range of 30 seconds or below.

### CROSS-REFERENCE TO RELATED APPLICATIONS

This application is based upon and claims the benefit of priority from Japanese Patent Application No. 2009-280047, filed on Dec. 10, 2009, the entire contents of which is incorporated herein by reference.

### TECHNICAL FIELD

Embodiments described herein relate generally to a development treatment and a computer-readable storage medium for supplying a developing solution onto a substrate to develop an extreme ultra violet (EUV) resist film thereon.

### BACKGROUND

In a semiconductor device manufacturing process using a photolithography technique, for example, a resist coating treatment of applying a resist solution onto a semiconductor wafer (hereinafter referred to simply as “wafer”) to form a resist film, an exposure processing of exposing a predetermined pattern on the resist film of the wafer, and a developing treatment of developing the exposed resist film on the wafer to form a resist pattern, are performed in order.

In recent years, chemically-amplified resists are in widespread use for the formation of the resist pattern. The chemically-amplified resists give a pattern through the phenomenon that acids are generated upon exposure and the acids in turn cause chemical reaction in the resist based on thermal diffusion activity, thereby causing a change in solubility of the radiation-exposed areas for a developing solution.

In the exposure processing described above, an exposure light source such as KrF laser (with a wavelength of 248 nm), ArF laser (with a wavelength of 193 nm), F2 laser (with a wavelength of 157 nm) or the like are employed to radiate light to the resist film on the wafer. In this case, in the subsequent developing treatment, a developing solution with a concentration of, for example, 2.38% by weight, is supplied onto the resist film formed on the wafer for the development of the resist film thereon (for example, see Japanese Laid-open Patent Publication No. 2005-221801). In the developing treatment, for example, the temperature of the developing solution is set to 23° C. and a time period of the developing treatment is set to 30˜60 seconds.

Incidentally, in recent years, to increase integration on semiconductor devices, a resist pattern formed on a wafer is being miniaturized. To do this, as the exposing light source to be used in the exposure processing, a light source which radiates an extreme ultra violet (EUV) with a wavelength in the range of, for example, 13˜14 nm is under consideration, which has a wavelength shorter than that of the KrF, ArF and F2 lasers.

Unfortunately, a EUV resist, which is used in EUV lithography and EUV-based exposure processing, is different than the resists used with the KrF, ArF or F2 lasers in terms of structure. Specifically, the EUV resist may have a low molecular weight relative to the KrF, ArF or F2 resists, which causes the EUV resist to easily undergo a chemical reaction based on developing solution activity. As such, the utilization of the related art technique described above, which supplies a developing solution onto a wafer whose EUV resist film undergoes development, results in a degraded line width roughness (LWR) of resist pattern. This fails to form a desired resist pattern onto the EUV resist film formed on the wafer.

### SUMMARY

The present disclosure has been developed in consideration of the above viewpoints and its object is to provide a method for properly forming a predetermined pattern onto an extreme ultra violet (EUV) resist film on a wafer W.

To attain the above object, according to one embodiment of the present disclosure, a developing treatment method is provided which supplies a developing solution onto a substrate to develop an extreme ultra violet (EUV) resist film thereon, wherein the temperature of the developing solution is set to fall within the range of 5° C. or higher to less than 23° C.

According to the research by the inventors of the present disclosure, it has been appreciated that when the temperature of the developing solution falls within the range of from 5° C. or higher to less than 23° C., a chemical reaction of the developing solution with the EUV resist film, particularly, permeation of the developing solution into the EUV resist film is inhibited. As a result, research has shown that the line width roughness (LWR) of the resist pattern formed on the EUV resist film is enhanced when compared to the prior art. Further, research has shown that development defects can be reduced when compared to the prior art. Therefore, according to the present disclosure, it is possible to properly form a predetermined resist pattern on the EUV resist film.

A time period during which the developing treatment is performed using the developing solution is in some embodiments set to fall within the range of 10 seconds or higher to less than 30 seconds.

The concentration of the developing solution is set in some embodiments to fall within the range of less than 2.38% by weight.

The method in some embodiments may further comprise, supplying a cleaning solution onto the substrate after supplying the developing solution onto the substrate, wherein a time period during which the cleaning solution is supplied is preferably set to fall within the range of 30 seconds or less.

According to another embodiment of the present disclosure, a program is provided which enables a computer to control a developing treatment apparatus for implementing said developing treatment method.

According to yet another embodiment of the present disclosure, provided is a computer-readable storage medium storing said program.

According to the present disclosure, it is possible to properly form a predetermined resist pattern on the EUV resist film.

### BRIEF DESCRIPTION OF THE DRAWINGS

FIG. 1 is a plan view showing the outline of a configuration of a coating and developing treatment system according to an illustrative embodiment.

FIG. 2 is a front view of a coating and developing treatment system according to an illustrative embodiment.

FIG. 3 is a rear view of a coating and developing treatment system according to an illustrative embodiment.

FIG. 4 is a schematic longitudinal sectional view showing a developing treatment apparatus.

FIG. 5 is a schematic transverse sectional view showing a developing treatment apparatus.

FIG. 6 is a graphical representation showing the relationships among developing solution temperatures, line width roughness (LWR) of a resist pattern and resist sensitivity of an EUV resist film.

FIG. 7 is a graphical representation showing the relationships among developing solution temperatures, exposure latitude (EL) and resist sensitivity of an EUV resist film.

FIG. 8 is a graphical representation showing the relationships among developing treatment times, LWR of resist pattern and resist sensitivity of an EUV resist film.

FIG. 9 is a graphical representation showing the relationships among developing treatment times, exposure latitude (EL) and resist sensitivity of an EUV resist film.

FIG. 10 is a graphical representation showing the relationships among concentrations of developing solution, LWR of resist pattern and resist sensitivity of an EUV resist film.

FIG. 11 is a graphical representation showing the relationships among concentrations of developing solution, exposure latitude (EL) and resist sensitivity of an EUV resist film.

FIG. 12 is a graphical representation showing the relationship between dose amount used in exposure processing and film thickness of an EUV resist film, if a period of pure water supply time is varied and a developing treatment time is 30 seconds.

FIG. 13 is a graphical representation showing the relationship between dose amount used in exposure processing and film thickness of a EUV resist film, if a pure water supply time is varied and a developing treatment time is 15 seconds.

FIG. 14 is a graphical representation showing the relationship between dose amount used in exposure processing and film thickness of a EUV resist film, if a pure water supply time is varied and a developing treatment time is 60 seconds.

FIG. 15 is a graphical representation showing the relationship between pure water supply times and developing defects, if a developing solution temperature is varied and a developing treatment time is 30 seconds.

### DETAILED DESCRIPTION

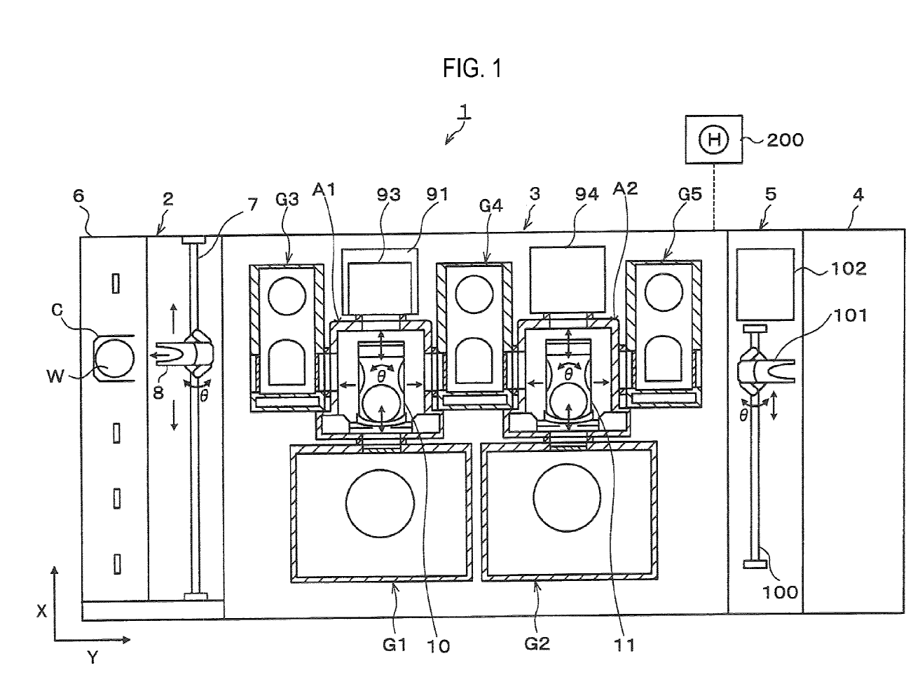

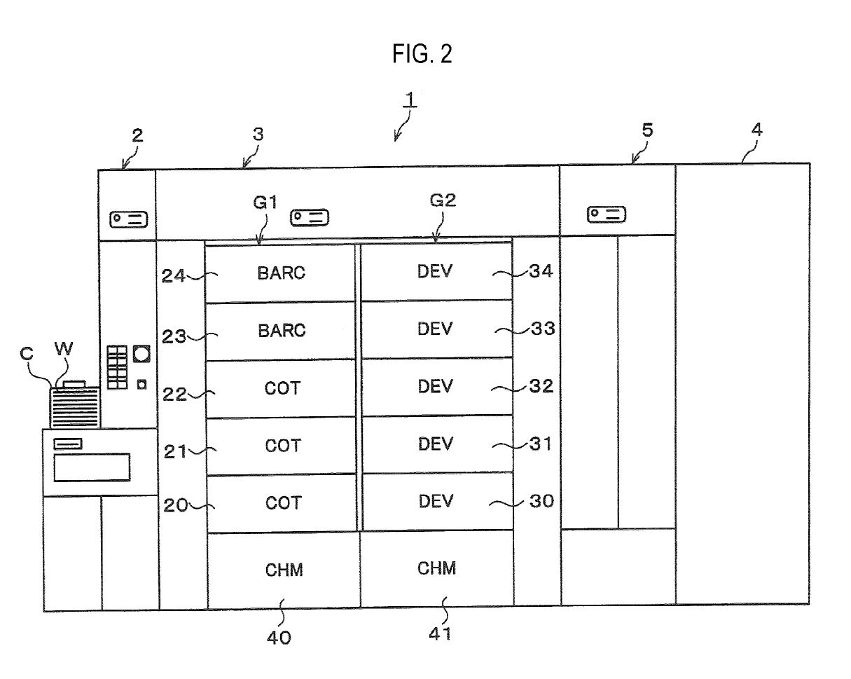

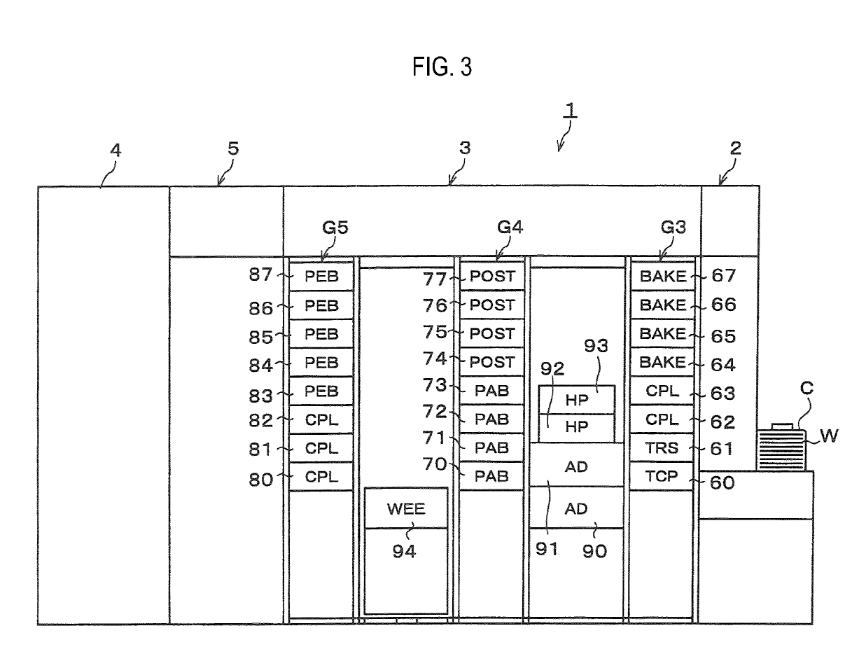

Embodiments will now be described in detail with reference to the drawings. FIG. 1 is a plan view showing the outline of a configuration of a coating and developing treatment system 1 having a developing treatment apparatus according to an illustrative embodiment. FIG. 2 is a front view of the coating and developing treatment system 1. FIG. 3 is a rear view of the coating and developing treatment system 1. In the illustrative embodiment, the coating and developing treatment system 1 may include an EUV-based exposure processing, i.e., EUV lithography.

As also shown in FIG. 1, the coating and developing treatment system 1 may include a cassette station 2 configured to carry, for example, 25 sheets of wafers W per cassette as a unit from/to the outside into/from the coating and developing treatment system 1 and carry the wafers W into/out of a cassette C. The coating and developing treatment system 1 may further include a processing station 3 with a plurality of various kinds of processing and treatment units, each configured to perform a predetermined processing or treatment in a manner of single wafer processing in the photolithography process, the plurality of processing and treatment units being multi-tiered. The coating and developing treatment system 1 may further include an interface station 5 configured to transfer the wafers W to/from an exposing unit 4 disposed adjacent to the processing station 3. These stations 2, 3 and 5 are integrally connected together. The exposing unit 4 may be provided with a light source (not shown) which radiates EUV (with a wavelength in a range of 13 nm to 14 nm).

In the cassette station 2, a plurality of cassettes C may be mounted on a cassette mounting stand 6 in one row in an X-direction (in a top-to-bottom direction in FIG. 1). In the cassette station 2, a wafer carrier 8 is provided which is movable in the X-direction on a carrier path 7. The wafer carrier 8 is also movable in a wafer-arrangement direction of the wafers W housed in the cassette C (in i.e., a Z-direction; the vertical direction), and thus can selectively access the wafers W in each of the cassettes C arranged in the X-direction.

The wafer carrier 8, which is rotatable in a O-direction around the Z-axis, can access a temperature regulating unit 60 and a transition unit 61 configured to deliver the wafers W, which will be described later, included in a third processing unit group G3 on the processing station 3.

The processing station 3 adjacent to the cassette station 2, may include, for example, five processing unit groups G1 to G5, in each of which a plurality of processing and treatment units are multi-tiered. On the side of the negative direction in the X-direction (in the downward direction in FIG. 1) in the processing station 3, the first processing unit group G1 and the second processing unit group G2 are placed in order from the cassette station 2 side. On the side of the positive direction in the X-direction (in the upward direction in FIG. 1) in the processing station 3, the third processing unit group G3, the fourth processing unit group G4 and the fifth processing unit group G5 are placed in order from the cassette station 2 side. Between the third processing unit group G3 and the fourth processing unit group G4, a first carrier unit A1 including therein a first carrier arm 10 for supporting and carrying the wafers W is provided. The first carrier arm 10 may selectively access the processing and treatment units in the first processing unit group G1, the third processing unit group G3, and the fourth processing unit group G4 and carry the wafers W. Between the fourth processing unit group G4 and the fifth processing unit group G5, a second carrier unit A2 including therein a second carrier arm 11 for supporting and carrying the wafers W is provided. The second carrier arm may selectively access the processing and treatment units in the second processing unit group G2, the fourth processing unit group G4 and the fifth processing unit group G5 and carry the wafers W.

As shown in FIG. 2, in the first processing unit group G1, solution treatment units each for supplying a predetermined liquid to the wafer W to treat, for example, resist coating units (COT) 20, 21, 22 each for supplying and coating a EUV resist solution onto the wafer W, and bottom coating units (BARC) 23 and 24 each for forming an anti-reflection film that prevents reflection of light at the time of exposure processing, are vertically stacked (five-tiered) in order from the bottom. In the second processing unit group G2, solution treatment units, for example, developing treatment units (DEV) 30 to 34 each for supplying a developing solution onto the wafer W to develop the wafer, are vertically stacked (five-tiered) in order from the bottom. Further, chemical chambers (CHM) 40 and 41 each for supplying various kinds of treatment solutions to the solution treatment units in the first and second processing unit groups G1 and G2 are provided at the lowermost tiers of the first processing unit group G1 and the second processing unit group G2, respectively. Further, the EUV resist, which is employed at EUV lithography, may be made of a relatively lower molecular weight than the related art resists such as KrF resist, ArF resist, F2 resist or the like.

As shown in FIG. 3, in the third processing unit group G3, for example, the temperature regulating unit (TCP) 60, the transition unit (TRS) 61, high-precision temperature regulating units (CPL) 62 and 63 each for temperature-regulating the wafer W under temperature control with a high-precision, and high-temperature heating units (BAKE) 64 to 67 each for heat-processing the wafer W at a high temperature, are vertically stacked (eight-tiered) in order from the bottom.

In the fourth processing unit group G4, pre-baking units (PAB) 70 to 73 each for heat-processing the wafer W after the resist coating treatment, and post-baking units (POST) 74 to 77 each for heat-processing the wafer W after the developing treatment, are vertically stacked (eight-tiered) in order from the bottom.

In the fifth processing unit group G5, a plurality of thermal processing units each for performing thermal processing on the wafer W, for example high-precision temperature regulating units (CPL) 80 to 82, and post-exposure baking units (PEB) 83 to 87 each for heat-processing the wafer W after exposure, are vertically stacked (eight-tiered) in order from the bottom.

On the side of the positive direction in the X-direction of the first carrier unit A1 as shown in FIG. 1, a plurality of processing and treatment units, for example, hydrophobic processing units (AD) 90 and 91 each for performing hydrophobic treatment on the wafer W, and heating units (HP) 92 and 93 each for heating the wafer W, are vertically stacked (four-tiered) in order from the bottom as shown in FIG. 3.

As shown in FIG. 1, on the side of the positive direction in the X-direction of the second carrier unit A2, for example, an edge exposure unit (WEE) 94 is disposed which selectively exposes only the edge portion of the wafer W to light.

In the interface station 5, for example, a wafer carrier 101 moving on a carrier path 100 extending in the X-direction and a buffer cassette 102 are provided as shown in FIG. 1. The wafer carrier 101 is movable in the Z-direction and is also freely rotatable in the O-direction, thereby accessing the exposing unit 4 adjacent to the interface station 5, the buffer cassette 102 and the fifth processing unit group G5 to carry the wafer W.

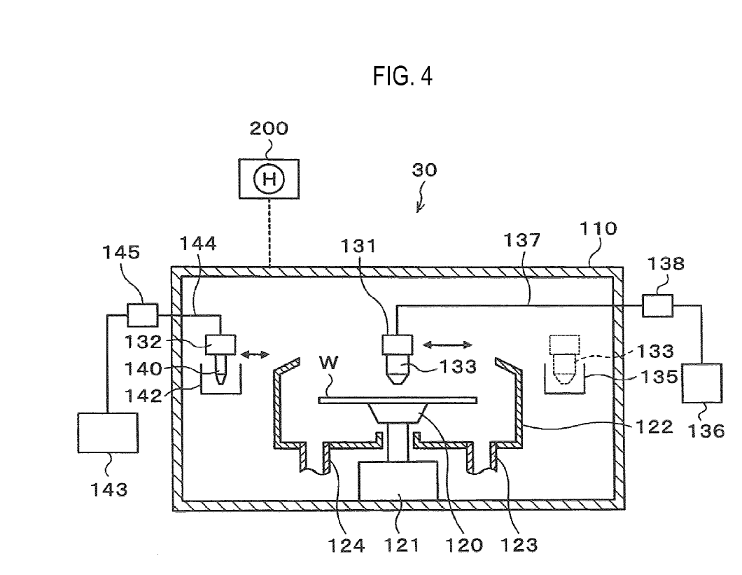

Below, a detailed description will be directed to the configuration of the above-described developing treatment units (DEV) 30 to 34. As shown in FIG. 4, the developing treatment unit 30 may include a treatment casing 110 with an inlet/outlet (not shown) formed on its side face, through which the wafer W is carried.

Disposed at the central portion in the treatment casing 110 is a spin chuck 120 for holding and rotating the wafer W. The spin chuck 120 may include a horizontal upper surface which is provided with, for example, a suction port (not shown) for sucking the wafer W. The suction from the suction port allows the wafer W to be sucked onto the spin chuck 120.

The spin chuck 120 may include, for example, a chuck driving mechanism 121 having a motor, which rotates the spin chuck 120 at a preset speed. The chuck driving mechanism 121 may be equipped with a lifting unit such as a cylinder for raising and lowering the spin chuck 120.

Around the spin chuck 120, a cup 122 is provided for receiving and collecting the liquid scattering or dropping from the wafer W. The cup 122 may include an opening at its top surface, which has a greater size than one of the wafers W to allow the spin chuck 120 to be elevated therethrough. The lower surface of the cup 122 is connected with a drain pipe 123 for draining the liquid collected in the cup 122 therethrough externally, and an exhaust pipe 124 for exhausting ambient gas in the cup 122 therethrough externally.

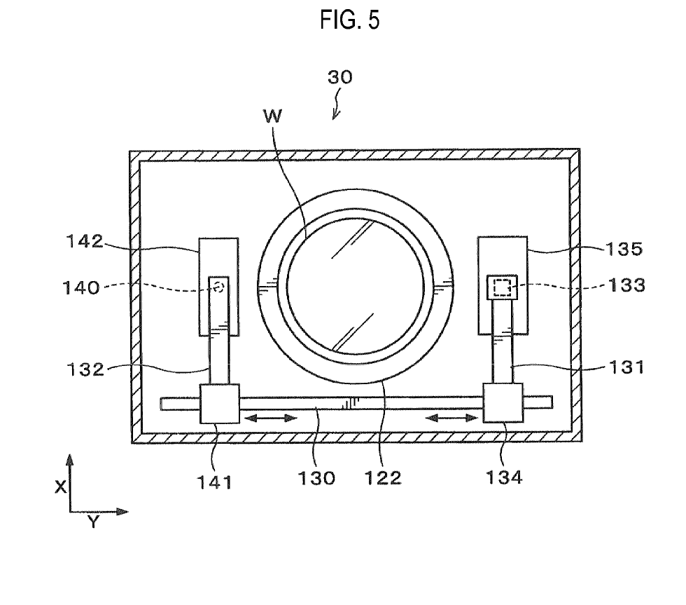

As shown in FIG. 5, a rail 130 extending along the Y-direction (i.e., the left and right direction in FIG. 5) is disposed in a negative X-direction (the lower direction in FIG. 5) of the cup 122. The rail 130 is formed, for example, from the outside of the cup 122 on the side in the negative Y-direction (the left direction in FIG. 5) to the vicinity of the end portion of the cup 122 on the side in the positive Y-direction (i.e., the right direction in FIG. 5). For example, two arms 131 and 132 are attached to the rail 130.

As shown in FIGS. 4 and 5, a developing solution supply nozzle 133 for supplying a developing solution is supported by the first arm 131. The first arm 131 is movable on the rail 130 by means of a nozzle driving unit 134 as shown in FIG. 5. As such, the developing solution supply nozzle 133 is movable from a waiting section 135 disposed outside the cup 122 on the side in the positive Y-direction to above the central portion of the wafer W in the cup 122. The developing solution supply nozzle 133 is also movable on the surface of the wafer W in the diameter direction. The first arm 131 is also movable in the vertical direction by means of the aforementioned nozzle driving unit 134, thereby adjusting a height of the developing solution supply nozzle 133.

As shown in FIG. 4, a supply pipe 137, which is in communication with a developing solution supply source 136, is connected to the developing solution supply nozzle 133. The developing solution is retained inside the developing solution supply source 136. The developing solution retained inside the developing solution supply source 136 may be adjusted in a concentration of less than 2.38% by weight. At the supply pipe 137, a supply equipment set 138 is disposed which is equipped with, for example, a valve or a flow regulating unit for regulating the flow of the developing solution, a temperature regulating unit for regulating the temperature of the developing solution, and the like.

To the second arm 132, a pure water supply nozzle 140 for supplying pure water as a cleaning solution is supported. The second arm 132 is movable on the rail 130 by means of a nozzle driving unit 141 as shown in FIG. 5. As such, the pure water supply nozzle 140 is movable from a waiting section 142 disposed outside the cup 122 on the side in the negative Y-direction to above the central portion of the wafer W in the cup 122. The second arm 132 is also movable in the vertical direction by means of the aforementioned nozzle driving unit 141, thereby adjusting a height of the pure water supply nozzle 140. While in the illustrative embodiment, the pure water has been explained to be utilized as the clean solution for the wafer, in other embodiments other solutions may be utilized.

A supply pipe 144 is connected to the pure water supply nozzle 140. As shown in FIG. 4, the supply pipe 144 is also in communication with a pure water supply source 143. Pure water is retained inside the pure water supply source 143. At the supply pipe 144, a supply equipment set 145 is mounted which is equipped with, for example, a valve or a flow regulating unit for regulating the flow of the pure water, and the like. In the above configuration, while the developing solution supply nozzle 133 of supplying the developing solution and the pure water supply nozzle 140 for supplying the pure water have been shown to be supported by means of separate arms, they may be supported by means of a single arm. Controlling the movement of the single arm enables control of the developing solution supply nozzle 133 or the pure water supply nozzle 140 and adjustment of the timing for supplying the developing solution or the pure water.

The developing treatment units (DEV) 31 to 34 has the same configuration as that of the developing treatment unit (DEV) 30, so a description thereof will be omitted to avoid duplication.

In the coating and developing treatment system 1 described earlier, a control unit 200 is provided as shown in FIG. 1. The control unit 200 as for example a computer, may be equipped with a program storage unit (not shown). Stored in the program storage unit is a program for the developing treatment on the wafer W in the developing treatment units 30 to 34. The program storage unit further stores a program by which the control unit 200 controls the transfer of the wafer W among the cassette station 2, the processing station 3, the exposing unit 4 and the interface station 5, or the operation of a driving system in the processing station 3, and the like, thereby allowing the coating and developing treatment system 1 to perform predetermined treatments on the wafer W. Furthermore, such programs may be stored in a computer-readable storage medium H such as a computer-readable hard disk (HD), a flexible disk (FD), a compact disk (CD), a magnet optical disk (MO), a memory card and the like. The programs stored in the storage medium H may be also installed in the control unit 200.

The coating and developing treatment system 1 of the illustrative embodiment may be configured as above. Subsequently, a description will be made as to a series of processes which are performed on the wafer W in the coating and developing treatment system 1.

Initially, when a cassette C in which a plurality of unprocessed wafers W are housed is mounted on the cassette mounting stand 6, the unprocessed wafers W are picked-up individually by the wafer carrier 8, and carried to the temperature regulating unit (TCP) 60 in the third processing unit group G3. The wafer W carried to the temperature regulating unit (TCP) 60 is temperature-regulated to a predetermined temperature. Next, the wafer W is carried by the first carrier unit A1 into a bottom coating unit (BARC) 23 where an anti-reflection film is formed on the wafer W. The wafer W on which the antireflection film has been formed is sequentially carried by the first carrier unit A1 to the heating unit (HP) 92, the high-precision temperature regulating unit (CPL) 62 and the hydrophobic processing unit (AD) 90 so that the wafer W is subjected to predetermined processing and treatment in each of the units. Thereafter, the wafer W is carried to the resist coating unit (COT) 20 by the first carrier unit A1 where a resist solution for EUV is applied onto the surface of the wafer W to form a resist film on the wafer W.

After that, the wafer W on which the resist film for EUV has been formed is carried by the first carrier unit A1 to the pre-baking unit (PAB) 70 where wafer W is subjected to a pre-baking treatment. Subsequently, the wafer W for which the pre-baking treatment has been finished is carried by the second carrier unit A2 to the edge exposure unit (WEE) 94 and the high-precision temperature regulating unit (CPL) 82 in sequence so that the wafer W is subjected to predetermined processing and treatment in each of the units. Thereafter, the wafer W is carried by the wafer carrier 101 in the interface station 5 to the exposing unit 4. In the exposing unit 4, a EUV light is radiated onto the EUV resist film formed on the wafer W so that a predetermined pattern is selectively exposed on the EUV resist film.

After that, the wafer W for which exposure processing has been finished is carried by the wafer carrier 101 to the post-exposure baking unit (PEB) 83 to undergo a post-exposure baking treatment. And then, the wafer W for which post-baking treatment has been finished is carried by the second carrier unit A2 to the high-precision temperature regulating unit (CPL) 81 where the wafer W is subjected to a temperature regulating treatment.

Subsequently, the wafer W is carried by the second carrier unit A2 to the developing treatment unit (DEV) 30. In the developing treatment unit (DEV) 30, the wafer W is mounted and held on the spin chuck 120. Then, the developing solution supply nozzle 133 at the waiting section 135 moves to the outer periphery of the wafer W by means of the first arm 131.

Subsequently, controlling the chuck driving mechanism 121 allows the spin chuck 120 to rotate the wafer W at a predetermined rotation speed. And then, the developing solution supply nozzle 133 supplies the outer periphery of the wafer W with a developing solution having a concentration of, for example, below 2.38% by weight. In such a case, the temperature of the developing solution discharged from the developing solution supply nozzle 133 is adjusted in a temperature range from 5° C. or higher to less than 23° C. by the temperature adjustment unit of the supplying equipment set 138. After that, the developing solution supply nozzle 133, while moving toward the central portion of the wafer W, discharges the developing solution to the EUV resist film formed on the wafer W. This allows the developing solution discharged from the developing solution supply nozzle 133 to be spirally supplied onto the wafer W. The developing solution is uniformly spread over the entire surface of the wafer W while being coated on the entire surface of the wafer W. This enables the EUV resist film formed on the wafer W to undergo development so that the exposed area in the EUV resist film is dissolved to form a resist pattern on the wafer W. In the wafer developing treatment of the illustrative embodiment, a developing treatment time at which the developing solution supply nozzle 133 supplies the developing solution onto the surface of the wafer W, may fall within the range from 10 seconds or higher to less than 30 seconds.

Upon completion of the developing treatment on the wafer W, the first arm 131 enables the developing solution supply nozzle 133 to move from a position above the central portion of the wafer W to the waiting section 135. Simultaneously, the second arm 132 enables the pure water supply nozzle 140 at the waiting section 142 to move to a position above the central portion of the wafer W. After that, while the wafer W is being rotated, the pure water supply nozzle 140 supplies pure water to the central portion of the wafer W so that wafer W is subjected to a cleaning treatment. In the cleaning treatment of the illustrative embodiment, a pure water supply time at which the pure water supply nozzle 140 supplies the pure water to the wafer W may fall within the range of 30 seconds or below.

Subsequently, the supplement of the pure water from the pure water supply nozzle 140 to the wafer W is terminated and simultaneously the rotation of the wafer W is accelerated so that the pure water remaining on the wafer W is washed away for drying. Thus, a series of developing treatment is completed.

When the EUV resist film on the wafer W is developed in the developing treatment unit (DEV) 30, the wafer W is carried by the second carrier unit A2 to the post-baking unit (POST) 74 where the post-baking treatment is performed, and then carried by the first carrier unit A1 to the high-precision temperature regulating unit (CPL) 63 where the wafer W is subjected to temperature regulation. And then, the wafer W is carried by the first carrier unit A1 to the transition unit (TRS) 61 and then returned to the cassette C by the wafer carrier 8. Thus, a series of photolithography treatments are terminated.

According to the illustrative embodiment, in the development treatment performed in the developing treatment unit (DEV) 30, the temperature of the developing solution to be supplied on the EUV resist film falls within the range from 5° C. or higher to less than 23° C., thereby rendering it possible to inhibit a chemical reaction of the developing solution with the EUV resist film, especially, permeation of the developing solution into the EUV resist film. This enhances the LWR of the resist pattern formed on the EUV resist film, thereby enabling a predetermined resist pattern to be properly formed on the EUV resist film.

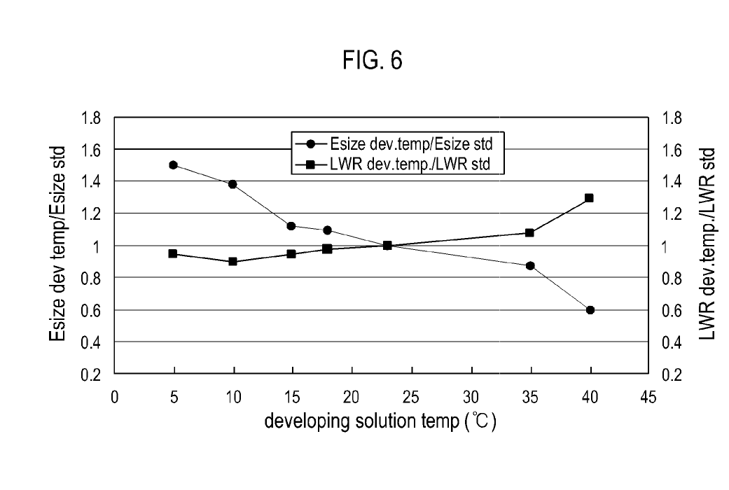

Herein, a description will be made as to an effect that the LWR of the resist pattern formed on the EUV resist film can be improved when the temperature of the developing solution is set to fall within the range of 5° C. or higher to less than 23° C. The inventors of the present disclosure have experimentally verified the effect under a condition that the temperature of the developing solution is varied within the range of 5° C. to 40° C. for measurement of the LWR of the resist pattern. In the experiment, in addition to the LWR of the resist pattern, a resist sensitivity (E size) of the EUV resist film was further measured. FIG. 6 shows the result of the above experiment. In FIG. 6, the horizontal axis depicts a developing solution temperature, and the vertical axis depicts the LWR of the resist pattern and the resist sensitivity of the EUV resist film. Based on the LWR of the resist pattern, FIG. 6 shows the ratio of LWR measured at each temperature condition of the developing solution to one measured at a standard condition wherein a developing solution temperature is 23° C. The ratio is referred to as “standard LWR” hereinafter. Similarly, as to the resist sensitivity of the EUV resist film, FIG. 6 shows the ratio of a resist sensitivity measured at each temperature condition of the developing solution to one measured at the standard condition, wherein the ratio is referred to as “standard Resist Sensitivity” hereinafter. The standard condition means a developing solution condition in the prior art.

Referring to FIG. 6, it can be appreciated that, if the developing solution temperature falls within the range of less than 23° C., the standard LWR becomes smaller than one, resulting in an enhanced LWR of the resist pattern. It was also found that if the developing solution temperature falls within the range of 5° C. or higher, the standard LWR falls within an allowable scope although it is on the rising trend. As a consequence, it can be appreciated that the appropriate range of the developing solution temperature in which the resist pattern LWR can be enhanced is within the range of 5° C. to less than 23° C. Further, the LWR and the resist sensitivity are in a trade-off relation. Thus, when the developing solution temperature falls within the range of 5° C. or higher to less than 23° C., it was found that the resist sensitivity also falls within an allowable scope although it slightly degraded.

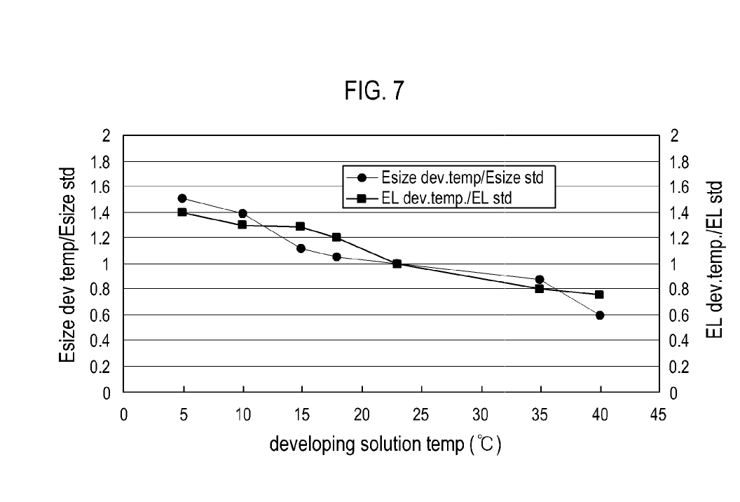

This experiment was also performed on the exposure latitude (EL). The exposure latitude represents the influence of a line width of the resist pattern on a dose amount used in exposure processing. Specifically, if the exposure latitude becomes greater, the deviation of the line width of the resist pattern from a target dimension becomes smaller even with a varied dose amount, resulting in enhanced performance of photolithography. FIG. 7 shows the result of the above experiment. Based on the exposure latitude, FIG. 7 shows the ratio of exposure latitude measured at each temperature condition of the developing solution to one measured at a standard condition wherein a developing solution temperature is 23° C. The ratio is referred to as “standard Exposure Latitude” hereinafter.

Referring to FIG. 7, it can be appreciated that, when the developing solution temperature falls within the range of 5° C. or higher to less than 23° C., the standard Exposure Latitude becomes larger than one, resulting in an enhanced exposure latitude. Thus, in view of this, it can be also appreciated that the appropriate scope of the developing solution temperature is within the range of 5° C. or higher to less than 23° C.

According to the illustrative embodiment above, the developing treatment time at which the developing solution is supplied to the EUV resist film on the wafer W is set to fall within the range greater than or equal to 10 seconds to less than 30 seconds, thereby rendering it possible to further inhibit a chemical reaction of the developing solution with the EUV resist film. This further enhances the LWR of the resist pattern formed on the EUV resist film.

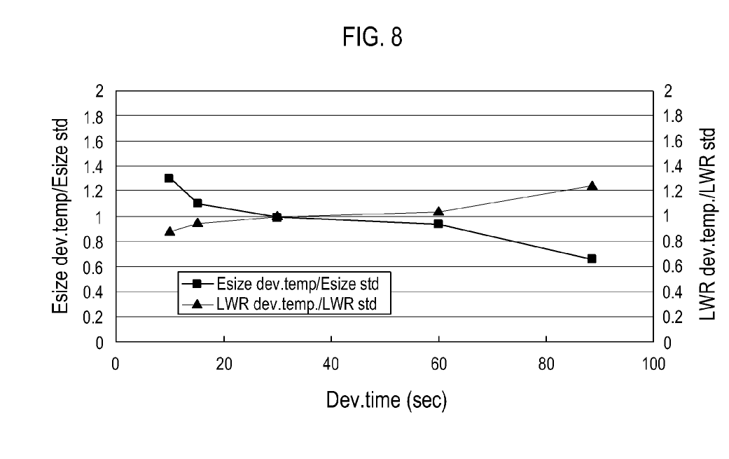

Herein, a description will be made as to the effect the LWR of the resist pattern on the EUV resist film is improved when the developing treatment time is set to fall within the range of 10 seconds or larger to less than 30 seconds. The inventors of the present disclosure have experimentally verified the effect under a condition that the developing treatment time is varied within the range of 10 seconds to 90 seconds for measurement of the LWR of the resist pattern. In the experiment, in addition to the LWR of the resist pattern, a resist sensitivity (E size) of the EUV resist film was further measured. FIG. 8 shows the result of the above experiment. In FIG. 8, the horizontal axis depicts a developing treatment time and the vertical axis depicts the LWR of the resist pattern and the resist sensitivity of the EUV resist film. Similar to FIG. 6, the LWR and the Resist Sensitivity in FIG. 8 are shown as the standard LWR and the standard resist sensitivity. The standard condition set at the experiment represents that the developing treatment time is set to 30 seconds.

Referring to FIG. 8, it can be appreciated that, when the developing treatment time falls within the range greater than or equal to 10 seconds to less than 30 seconds, the standard LWR becomes smaller than one, resulting in an enhanced LWR of the resist pattern. As a consequence, it can be appreciated that the appropriate range of the developing treatment time which the resist pattern LWR is enhanced is within the range of 10 seconds or larger to less than 30 seconds. When the developing treatment time falls within the range of 10 seconds or larger to less than 30 seconds, it was found that the resist sensitivity falls within an allowable scope although it slightly degraded.

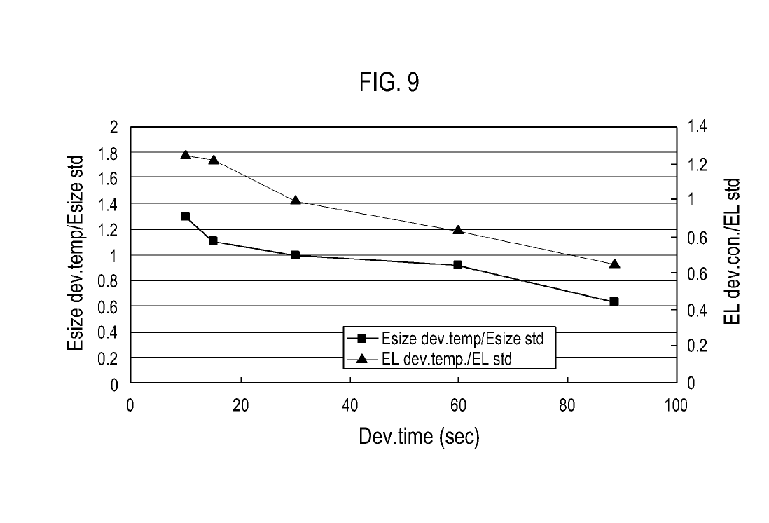

This experiment was also performed on the exposure latitude (EL). FIG. 9 shows the result of the above experiment. Similar to FIG. 7, the exposure latitude in FIG. 9 is shown as the standard Exposure Latitude. Referring to FIG. 9, it can be appreciated that, when the developing treatment time falls within the range of 10 seconds or larger to less than 30 seconds, the standard Exposure Latitude becomes larger than one, resulting in an enhanced exposure latitude. As a consequence, it can be also appreciated that the appropriate range of the developing treatment time is within the range of 10 seconds or larger to less than 30 seconds.

According to the illustrative embodiment above, the concentration of the developing solution to be supplied onto the EUV resist film on the wafer W is set to be less than 2.38% by weight, thereby rendering it possible to further inhibit a chemical reaction of the developing solution with the EUV resist film. This further enhances the LWR of the resist pattern on the EUV resist film.

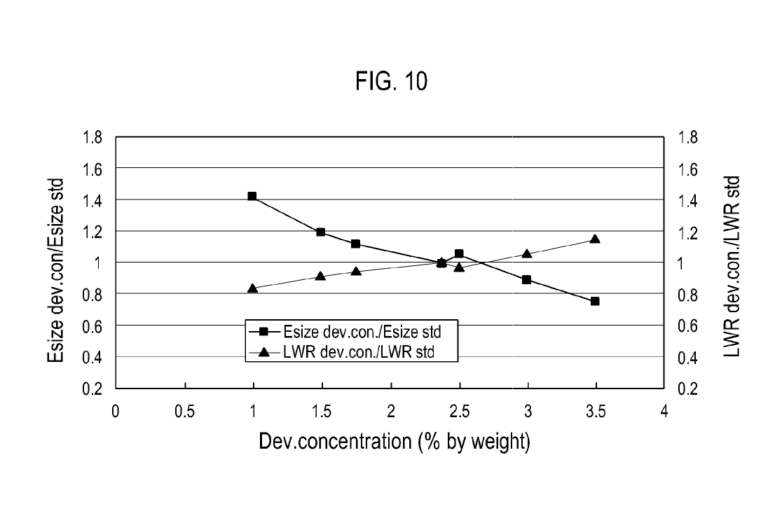

Herein, a description will be made as to the effect the LWR of the resist pattern formed on the EUV resist film is improved when the concentration of the developing solution is set to be less than 2.38% by weight. The inventors of the present disclosure have experimentally verified the effect under a condition that the concentration of the developing solution is varied within the range of 1% to 3.5% by weight for measurement of the LWR of the resist pattern. In the experiment, in addition to the LWR of the resist pattern, a resist sensitivity of the EUV resist film was further measured. FIG. 10 shows the result of the above experiment. In FIG. 10, the horizontal axis depicts a concentration of developing solution and the vertical axis depicts the LWR of the resist pattern and the resist sensitivity of the EUV resist film. Similar to FIG. 6, the LWR and the Resist Sensitivity in FIG. 10 are shown as the standard LWR and the standard resist sensitivity. The standard condition set in the experiment represents that the concentration of the developing solution is set to be 2.38% by weight.

Referring to FIG. 10, it can be appreciated that, when the concentration of the developing solution falls within the range of less than 2.38% by weight, the standard LWR becomes smaller than one, resulting in an enhanced LWR of the resist pattern. As a consequence, it can be also appreciated that the appropriate range of the concentration of the developing solution in which the resist pattern LWR is enhanced is within the range of less than 2.38% by weight. Further, when the concentration of the developing solution falls within the range of less than 2.38% by weight, it was found that the resist sensitivity falls within an allowable scope although it slightly degraded.

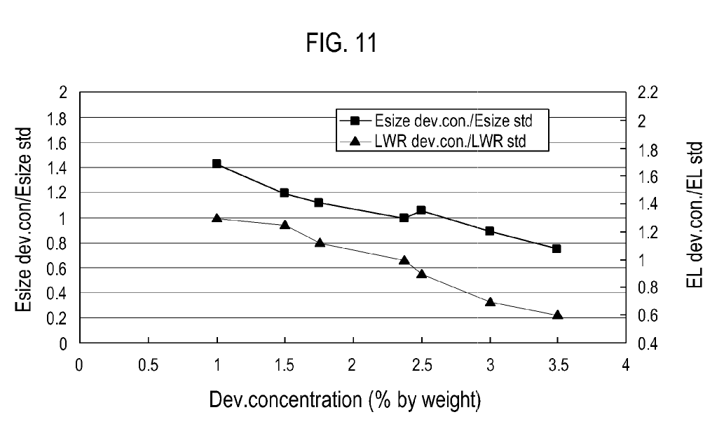

This experiment was also performed on the exposure latitude. FIG. 11 shows the result of the above experiment. Similar to FIG. 7, the exposure latitude in FIG. 11 is shown as the standard Exposure Latitude. Referring to FIG. 11, when the concentration of the developing solution falls within the range of less than 2.38% by weight, it can be appreciated that the standard Exposure Latitude becomes larger than one, resulting in enhanced exposure latitude. As a consequence, it is also appreciated that the appropriate concentration of the developing solution is within the range of less than 2.38% by weight.

According to the illustrative embodiment above, in the wafer cleaning treatment performed in the developing treatment unit (DEV) 30, the pure water supply time at which the pure water supply nozzle 140 supplies the pure water onto the wafer W falls within the range of less than 30 seconds. According to the research by the inventors of the present disclosure, it has been appreciated that a prolonged pure water supply time results in a swollen EUV resist film, thereby rendering the EUV resist film thick. On the other hand, it has been appreciated that a short period of pure water supply time, preferably less than 30 seconds, inhibits the EUV resist film from being swollen, thereby making it possible to form the resist pattern in a desired shape.

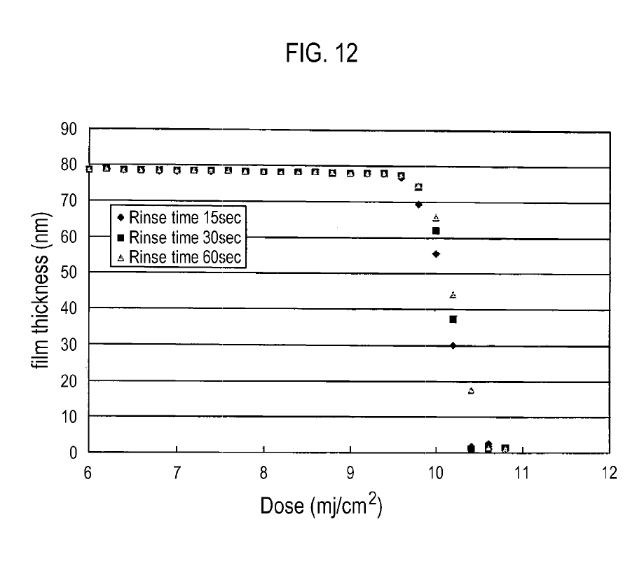

Herein, a description will be made as to the effect that the swelling of the EUV resist film is inhibited for a short period of pure water supply time, preferably less than 30 seconds. The inventors of the present disclosure have experimentally verified the effect under a condition that the dose amount to be used in the exposing process is varied at 15, 30 and 60 seconds of the pure water supply times. In such a case, the developing treatment time was set to 30 seconds. FIG. 12 shows the result of the above experiment. In FIG. 12, the horizontal axis depicts a dose amount used in the exposure processing, and the vertical axis depicts the thickness of the EUV resist film.

Referring to FIG. 12, for the dose amount falling within the range of 9.5 mj/cm² to 10.5 mj/cm², in a unstable area between a unexposed and an exposed portion in the EUV resist film, that is, in an area corresponding to the sidewall face of the EUV resist film, the degree of film decrease depends on pure water supply times. When the pure water supply time is set to 60 seconds, an amount of film decrease is so small as to render the film thickness thick. That is, the EUV resist film is swollen. On the other hand, when the pure water supply time is set to 15 or 30 seconds, an amount of the film decrease is so large as to inhibit the EUV resist film from being swollen. In view of this, it can be appreciated that the pure water supply time should be in some embodiments a short period of time, and in some examples, less than 30 seconds.

It can be also appreciated that, in a small range of dose amount, the amount of film decrease of the EUV resist film is so small as to result in a slight variation in film thickness of the EUV resist film before and after the developing treatment. This enables the formation of a pertinent thickness of the EUV resist film.

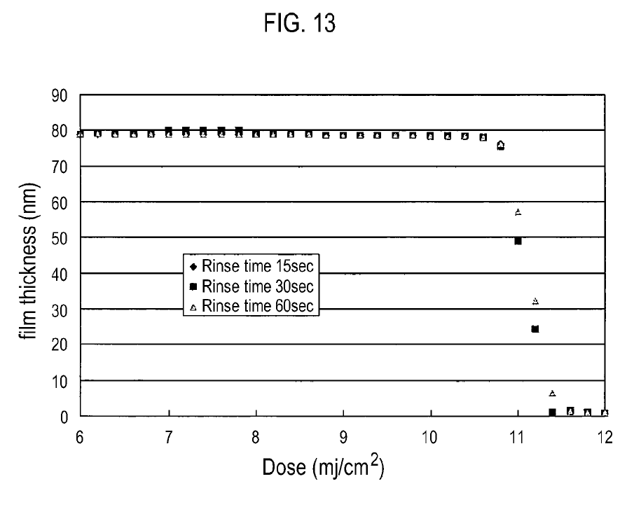

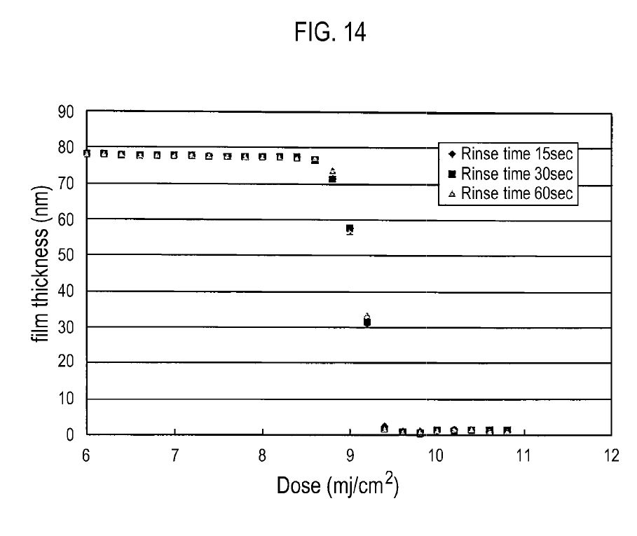

FIG. 13 shows the case where the pure water supply time in the developing treatment is set to 15 seconds. FIG. 14 shows the case where the pure water supply time in the developing treatment is set to 60 seconds. As is apparent from FIGS. 13 and 14, it can be appreciated that if the pure water supply time is set to be a short period of time, preferably less than 30 seconds, then the EUV resist film can be prevented from being swollen. Specifically, it can be appreciated that shortening the pure water supply time can inhibit the EUV resist film from being swollen, irrespective of the developing treatment time.

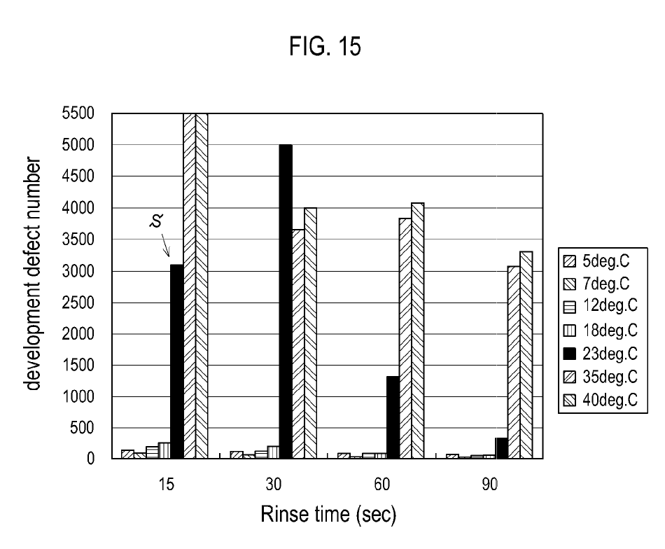

A description will be made as to the effect that development defects of the EUV resist film can be reduced. The development defects may include pattern collapse after developing treatment, precipitation-based defects, residue defects or the like. The inventors of the present disclosure have experimentally verified the effect under a condition that the temperature of the developing solution is varied within the range of 5° C. to 40° C. for measurement of the development defects. FIG. 15 shows the result of the above experiment. In FIG. 15, the horizontal axis depicts a pure water supply time, and the vertical axis depicts the number of the development defects. A portion indicated by the arrow S is the number of development defects in the standard condition (the developing solution temperature of 23° C. and the pure water supply time of 15 seconds).

Referring to FIG. 15, it can be appreciated that, when the developing solution temperature falls within the range of less than 23° C., the number of the development defects is drastically decreased compared to the developing solution temperature of 23° C. or higher, thereby reducing the development defects. Further, it can be appreciated that, even when the developing solution temperature falls within the range of 23° C. or higher, prolonging the pure water supply time can reduce the development defects.

In the illustrative embodiment above, the developing solution temperature has been explained to be in the range of 5° C. or higher to less than 23° C. However, in other embodiments, the developing solution temperature may be in the range of 23° C. or higher to 40° C. or below. In such a case, as shown in FIG. 6, the range of the standard LWR is slightly larger than one but still within the allowable scope.

Similarly, while the developing treatment time has been explained to be in the range of 10 seconds or higher to less than 30 seconds in the illustrative embodiment above, the developing treatment time may be 30 seconds. Further, while the concentration of the developing solution has been explained to be in the range of less than 2.38% by weight in the illustrative embodiment above, the concentration of the developing solution may be in the range of 2.38% or higher to 3.0% or less by weight.

While the temperature regulating unit of adjusting the temperature of the developing solution has been explained to be disposed inside the supplying equipment set 138 in the illustrative embodiment above, the temperature regulating unit may be disposed in the vicinity of the developing solution supply nozzle 133. This allows the temperature of the developing solution to be adaptively and firmly adjusted to a predetermined temperature.

While the developing solution having a predetermined temperature has been explained to be retained inside the developing solution supply source 136 in the illustrative embodiment above, a temperature regulating unit of adjusting the temperature of the developing solution may be disposed in the developing solution supply source 136. This allows the concentration of the developing solution to be adaptively adjusted to a predetermined concentration.

Further, in the illustrative embodiment above, the developing solution supply nozzle 133 has been explained to supply the developing solution onto the EUV resist film formed on the wafer W while moving from the outer periphery of the wafer W to its central portion. However, in other embodiments, the developing solution supply nozzle 133 may supply the developing solution onto the central portion of the wafer W. Under such a configuration, a centrifugal force involved in the rotation of the wafer W allows the developing solution supplied onto the central portion of the wafer W to be spread onto the wafer W.

While certain embodiments have been described, these embodiments have been presented by way of example only, and are not intended to limit the scope of the inventions. Indeed, the novel methods and mediums described herein may be embodied in a variety of other forms; furthermore, various omissions, substitutions and changes in the form of the embodiments described herein may be made without departing from the spirit of the inventions. The accompanying claims and their equivalents are intended to cover such forms or modifications which would fall within the scope and spirit of the inventions. The technical features of the illustrative embodiment are also applicable treating substrates other than the wafer, such as a flat panel display (FPD) and a mask reticule for a photo mask.

The present disclosure is useful in supplying a developing solution onto a substrate such as a semiconductor wafer to develop an EUV resist film formed on the substrate.

What is claimed is:

1. A developing treatment method for supplying a developing solution onto a substrate to develop an extreme ultra violet (EUV) resist film thereon, the method comprising,
supplying a developing solution onto a substrate wherein the temperature of the developing solution is greater than or equal to 5° C. and less than 23° C.

2. The method of claim 1, wherein a time period during which the developing treatment is performed using the developing solution is greater than or equal to 10 seconds and less than 30 seconds.

3. The method of claim 1, wherein the concentration of the developing solution is less than 2.38% by weight.

4. The method of claim 3 further comprising,
supplying a cleaning solution onto the substrate after supplying the developing solution,
wherein a time period during which the cleaning solution is supplied is less than or equal to 30 seconds.

5. The method of claim 2 further comprising,
supplying a cleaning solution onto the substrate after supplying the developing solution,
wherein a time period during which the cleaning solution is supplied is less than or equal to 30 seconds.

6. The method of claim 1, wherein the concentration of the developing solution is less than 2.38% by weight.

7. The method of claim 6 further comprising,
supplying a cleaning solution onto the substrate after supplying the developing solution,
wherein a time period during which the cleaning solution is supplied is less than or equal to 30 seconds.

8. The method of claim 1 further comprising,
supplying a cleaning solution onto the substrate after supplying the developing solution,
wherein a time period during which the cleaning solution is supplied is less than or equal to 30 seconds.

9. A computer-readable storage medium storing a program which is executed in a computer of a control device for controlling a development treatment apparatus thereby performing the developing treatment method of claim 1 by the development treatment apparatus.
